(19) United States
(12) Patent Application Publication
(10) Pub. No.: US 2008/0304299 A1
(43) Pub. Date: Dec. 11, 2008

(54) Low voltage LED drive from 120VAC line

(76) Inventor: Ronald M. Bormann, McAllen, TX (US)

Correspondence Address: JOHN F. BRYAN, 8291 LAKESIDE DRIVE, ENGLEWOOD, FL, 34224, US

(21) Appl. No.: 11/879,615

(22) Filed: Aug. 16, 2007

Related U.S. Application Data
(60) Provisional application No. 60/843,627, filed on Sep. 11, 2006.

(51) Int. Cl. H02M 7/12

(52) U.S. Cl. 363/89

(57) ABSTRACT

A highly efficient DC power supply is converted directly off-line from an A.C. or DC voltage source to have output current or voltage regulation from a low level approaching zero, up to the level of maximum capacity and has a DC power supply voltage and a DC voltage source for operating integrated circuits that is independent of output voltage or current. The DC power supply voltage is connected to a transformer input and switched “Off” and “On” in a pulse width modulated mode at a frequency rate above 1000 Hz and has the transformer output filtered through “buck” stage, so as to permit pulse width control to as much as 90% “on-time”, without damage to circuit components or load.

### This is a nonprovisional application claiming the benefit of the filing date of provisional application No. 60/843,627, filed on Sep. 11, 2006

### TECHNICAL FIELD

The present invention relates generally to the field of DC power supplies and more particularly, to such power supplies as are adapted to provide accurate control of the output current over a broad range of AC input voltage.

### BACKGROUND

At the present, Light Emitting Diode (LED) technology has advanced so that high intensity examples can emit white light at a lumen intensity equivalent to a 50 Watt halogen bulb, while consuming less than 10 Watts. The efficiency of these LEDs is even higher than is found in fluorescent lighting fixtures and they have a lifetime of 50,000 hours or more. LEDs in general operate with a fixed voltage drop of about 3.8 volts and architectural lighting LEDs are rated for specific maximum currents of from 20 to 750 ma or more, according to the characteristics of the particular unit. In all cases, the current must be tightly regulated at a constant, maximum level in order to avoid LED damage. For dimming purposes, the current may also be controlled over a lower, variable range.

The obvious, and most common way to drive LEDs is to connect a number of them in series, with a fixed resistance of a value selected to control current for lumen output and/or electrical efficiency. This method also requires that input voltage be regulated at the level for which the resistance value is selected, and will provide a workable drive, at the expense of power dissipated as heat in the resistor.

At this time, although it would be most desirable to have screw-in LED lighting fixtures, there is no commercially viable way to connect LEDs directly to a 120-240 VAC line, so as to utilize their efficiency potential for lighting, without the use of bulky transformers or ballasts.

There are other DC power applications, such as the operation of a thermoelectric cooling elements (TECs) and cold cathode florescent lighting (CCFL), as used in computer and flat screen TV backlighting, which can benefit greatly in performance and efficiency through the use of a closely regulated DC power supply. In some such applications, the output must be variable, in others it must be constant but always, overall power efficiency is of prime importance. There are no prior art DC switching power supplies that can operate efficiently off-line to provide a regulated output ranging from zero to maximum drive capacity, in terms of either amperage or voltage.

In driving TECs for refrigeration use, sufficient power must be available to cool the contents quickly from room temperature and yet have the ability to drive efficiently at a power level low enough to just barely offset heat leakage back into the refrigerated area. The control must be capable of smoothly ramping voltage up and down, since an abrupt change, such as is characteristic of a simple “on & off” thermostatic switch, can cause thermal shock and TEC failure. Another desirable characteristic for refrigeration use is that there be less than 10% AC ripple, inasmuch as excessive ripple damages TECs and reduces efficiency.

Direct Current (DC) switching power supplies are generally used to provide electrical power for applications requiring an essentially constant input voltage and such circuits are common in the prior art. The most basic DC supply, in which a bridge rectifier and filter capacitors change AC into pure DC output, does not contemplate any form of the efficient voltage or current regulation needed in power sensitive applications, nor means of compensation for line voltage variations.

A well-known regulation technique utilizes a Pulse Width Modulator (PWM) and a Metal Oxide Semiconductor Field Effect Transistor (MOSFET). The MOSFET is a very fast voltage controlled switch, turning on and off in a matter of nanoseconds. The square wave from the PWM applies the controlling signal, so that when the MOSFET is switched “On”, current flows through it and when it is “Off”, flow is blocked. Output is varied by the relative length of MOSFET “On Time” and “Off Time”. At 25% “Off-Time” and 75% “On-time”, output would be approaching maximum and at 75% “Off Time” output would be approaching minimum.

There are also semi-resonate power supplies that use frequency variation to control output. These are based on the fact that an inductor and capacitor balanced to resonate at a given frequency will offer almost no impedance to the flow of electricity and yet have a very sharp change in impedance when the drive frequency is shifted slightly. These units are useful for regulation over no more than a 5% to 15% range.

A first object of the present invention therefore, is to provide an AC rectifying, DC power supply capable of output voltage regulation ranging from zero volts to its maximum drive capacity. A second object is that this DC power supply also be able to provide output current regulation at a level ranging from zero amps to its maximum output capacity. A third object is that output regulation of this DC power supply be smoothly incremental across the full range. A fourth object is that this DC power supply have greater overall efficiency than prior art power supplies for similar applications. A fifth object is that the DC power supply of the present invention have less than 10% AC ripple. A sixth object is that this DC power supply be capable of direct line connection (AC or DC) to serve as a direct replacement of existing fluorescent and incandescent lighting fixtures. A seventh object is that this DC power supply be capable of being provided in a form to screw into an existing incandescent light socket. Yet another object is that this power supply be capable of operating directly off line at any voltage from 80V to 280V (AC or DC), and a final object is that this power supply be inexpensive, so as to be commercially viable for residential room lighting, home refrigeration and other applications, such as, but not limited to, cold cathode florescent lighting (CCFL) as used in computer and flat screen TV backlighting.

### SUMMARY OF THE INVENTION

The present invention relates to or employs some steps and apparatus well known in the electrical arts, thus, not the subject of detailed discussion herein. This invention addresses the aforesaid objectives in a preferred embodiment employing technology understood by those skilled in the art.

There are several “functional blocks” necessary for the Universal Input Wide Range Output power supply. The first is an A.C. to DC conversion stage, which should also pass electric power that is already DC If power factor correction is required, it can be applied in this section by prior art means.

The next stage required is an “always on” low voltage power supply that provides operating voltage for all other portions of the circuit. Inasmuch as 60 Hz line transformers are comparatively large and energy wasteful, a small, self starting switching power supply is provided for this stage. This auxiliary power supply starts up by charging a capacitor through a high value input resistor until the under-voltage lockout of the controller IC is reached. The supply begins to run from this stored charge at a high frequency, until rectified power from a “bias” winding on this supply's output transformer takes over at a level slightly higher than lockout voltage. This effectively removes the input resistor from the circuit. This technique is not appropriate to the operation of the main supply, inasmuch as its output may drop to zero, so that a bias winding on the main output transformer would not supply voltage.

The third stage of this design is a pulse width modulator (PWM) that is capable of providing pulses from 0 to 90% duty cycle (on-time to off-time). In most switching power supplies this would be limited to 50% duty cycle to prevent pushing the inductor beyond saturation. This design, being of a feed forward (transformer based) topology and using the output “buck” stage simply for filtering, avoids this problem. This capability of large variation in duty cycle gives a large range of control over the output, with high resolution of the control. Running the feed forward/buck topology at a high frequency, which may be in the MHz range, eliminates the need for a large 60 Hz transformer.

An off-line buck or the Frequency Shift Regulation of my pending patent application Ser. No. 11/454,279, filed Jun. 17, 2006, might also be used in place of the feed forward/buck topology, but at lower efficiency.

The next stage of this design is a MOSFET driver circuit. This device translates the signal level drive from the PWM to a higher power level capable of driving the main switching device (MOSFET in this example).

The switching device controls current through the main transformer with a duty cycle that has been set by the PWM. The ratio from primary to secondary of this transformer is such that with the lowest voltage expected being present at the line input, and the PWM duty cycle at 90%, the voltage at the output is the maximum that will be expected from a particular application of this supply.

The diode, inductance and capacitance, “buck” stage of this supply is used to rectify and filter the power coming from the transformer secondary. The main reason for using this stage is that, during the off period at very low percentage duty cycle, when there is no power coming from the transformer, the inductor will be providing voltage to the output due to the collapsing magnetic field applied through the diode. Careful selection of values for the inductance and capacitance will serve to limit ripple and fall-off of output voltage under load.

Feedback to control the power supply can be derived by many different means, from voltage sensors, current sensors, or by monitoring the process that is being driven by this supply (temperature of the area to be cooled in the case of thermoelectric refrigeration) and developing a feedback signal from this.

### BRIEF DESCRIPTION OF THE DRAWINGS

The accompanying drawings are incorporated into the specification to assist in explaining the present invention. The drawings illustrate a preferred example of how the invention can be made and used and are not to be construed as limiting the invention to only those examples illustrated and described. The various advantages and features of the present invention will be apparent from a consideration of the drawings in which:

FIG. 1 is a schematic diagram of a usable circuit for providing rectified high and low DC voltage sources for the present invention;

FIG. 2 is a schematic diagram of a usable circuit for the main power supply the present invention;

FIG. 3 is a schematic diagram showing a preferred embodiment of circuit of the present invention for providing rectified high and low DC voltage;

FIG. 4 is a schematic diagram of a preferred embodiment of the variably controllable DC power supply of the present inventions;

FIG. 5 is a schematic diagram of a control circuit the current output of the variably regulated DC power supply of FIG. 4; and

FIG. 6 is a schematic diagram of a control circuit for the voltage output of the variably controllable DC power supply of FIG. 4.

### DETAILED DESCRIPTION OF THE DRAWINGS

The present invention is described in the following by referring to drawings of examples of how the invention can be made and used. In these drawings, reference characters are used throughout the views to indicate corresponding parts. The embodiment shown and described herein is exemplary. Many details are well known in the art, and as such may be neither shown nor described.

As shown in FIG. 1, a schematic diagram of a possible circuit 100 for providing rectified high and low DC, line voltage (120VAC in the U.S.) is rectified and filtered by rectifying bridge 18 and capacitor 22 to provide the input voltage supply (169VDC in the U.S.) at connection 130 for either main power supply 200 or 400. The low voltage signal supply capacitor 24 is chosen to have an AC impedance such that all but 8.5VAC will drop thereacross. This AC impedance acts as a loss free resistance, wherein the voltage drop does not convert to heat. This 8.5VAC is rectified, filtered and regulated to supply 12VDC at connection 120 by rectifying bridge 26, filter capacitor 28 and zener diode 30. Circuit 100 is problematic and hence, not preferred, inasmuch as there must be two separate grounds, totally isolated from one another.

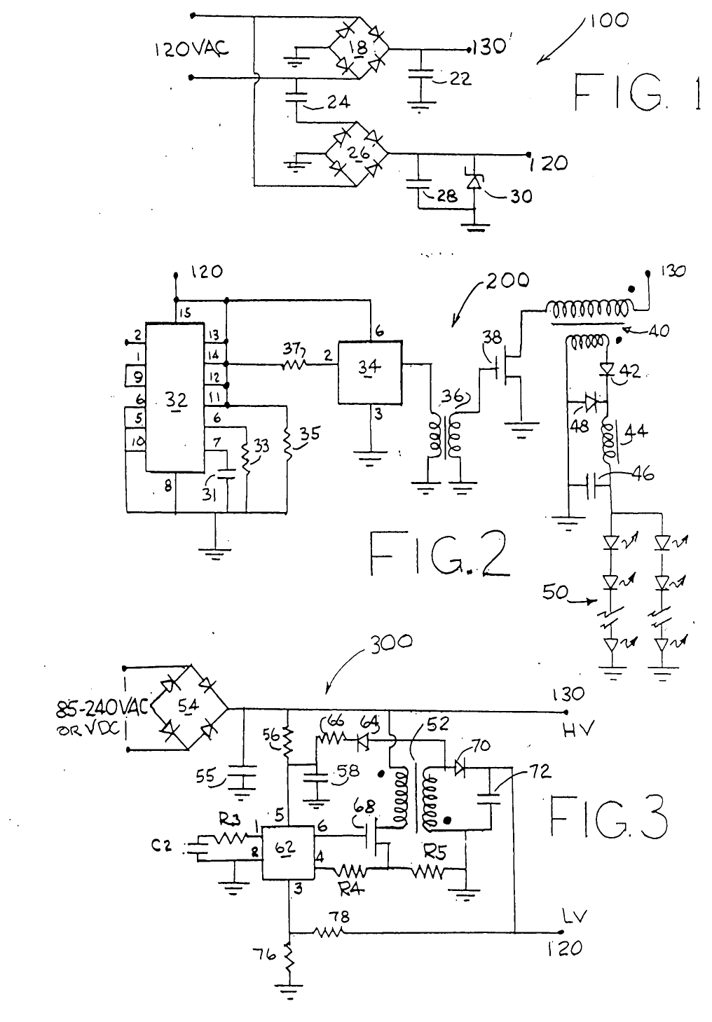

In FIG. 2, is shown a schematic diagram of a possible circuit 200 for the main power supply, operating on the 12VDC supplied at connection 120. Here, pulse width modulator (PWM) 32 in this case, shown with numbered pin connections as a SG3524 integrated circuit (IC), with 0.001 mmf capacitor 31 to pin 7, 2,000 ohm resistor 33 to pin 6. 140 ohm resistor 35 and 680 ohm resistor 37 are connected to low voltage supply connection 120. In this case, PWM 32 runs at 425 KHz, to provide a pulse width modulated signal, which may be varied through an on-time toff-time ratio of from 0% and 90% for purposes of output regulation. This signal is input to driver circuit 34, in this case, shown with numbered pin connections as a TC427 IC, where it is translated to a higher level for driving main switching device 38, a MOFSET. Driver circuit 34 drives pulse transformer 36 which, with a 1/1 turns ratio, couples this signal to the gate terminal of switching device 38, while isolating the low voltage supply from the 169VDC supply. Thus, switching device 38 controls power flowing from the high voltage provided at connection 130, through the primary of transformer 40, and in step with the PWM signal originally developed by PWM 32 in typical feed forward converter topology. The secondary of transformer 40 isolates the output drive from the line and is wound with fewer turns than the primary, giving a step-down of voltage. Diode 42 acts as a steering diode, to prevent any reverse path back through the secondary of transformer 40. During the “on-time” the PWM drive charges inductor 44, which is filtered by capacitor 46. During the “off-time” of the PWM drive, the magnetic field developed in inductance 44 will cause electrical flow back through diode 48, again being filtered by capacitor 46, in typical buck configuration.

Load 50, in this instance, is provided by LEDs in paralleled strings 51 across capacitor 46, and feedback is used to control the current flowing through the LEDs. Since all power is at much higher frequency than 60 Hz line frequency, the magnetics (transformer 40 and inductor 44) are physically small. It should be noted that paralleled LED strings 51 are vulnerable to any resistive imbalance and hence not preferred.

Inasmuch as resistance is not used to run the low voltage supply, and as long as the components are appropriately rated, this circuit will work on both USA and European line voltages.

FIG. 3 shows a preferred embodiment for a rectified low voltage D.C auxiliary supply 300, for operating power for all ICs in main supplies 200 or 400. Note the polarity dots on high frequency transformer 52, indicating that this circuit is configured as a flyback supply. While other operating modes might work, the flyback mode is smaller and more simple than other configurations, so as to lend itself best to miniaturization. Power, with filtering by capacitor 55, flows from rectifying bridge 54 to the high voltage buss connection 130, and is tapped through starting resistor 56, to charge capacitor 58 over a short period of time. Once the voltage on capacitor 58 exceeds start-up lockout voltage, pulse width modulator 62, in this case, an LTC3803 device, begins to drive auxiliary transformer 52. Capacitor 58 is sized large enough to support several cycles of operation and, once the circuit is running in a stable mode, is kept charged by diode 64 and resistor 66, effectively taking resistor 56 out of the circuit to provide virtually loss free power for integrated circuit operation. Most significantly, auxiliary supply 300 starts off-line and, with PWM LTC3803 device 62, switches MOFSET 68 at an elevated frequency, chosen to reduce the physical size of components. This preferred embodiment operates at 25 KHz, so as to use readily available components, but any switching frequency, from 1,000 Hz to 4 MHz, according to the designer's choice may be used, depending upon overall size limitations and interference considerations. At the higher frequencies, the time involved in switching becomes increasingly more significant and efficiency may begin to drop, but the higher the frequency, the smaller the magnetic and capacitive components. The output voltage can be regulated at any appropriate value for a given application, usually 8.5 VDC, but generally any required value up to 36 VDC or more, as limited by the maximum voltage rating of the circuit components.

Diode 70 and capacitor 72 rectify and filter the output of transformer 52 to deliver low voltage supply at low voltage connection 120. This operating voltage is maintained regardless of the output of main supply 200 or 400. Furthermore, voltage feedback developed at pin 3 of the LTC3803 device 62 by resistors 76 and 78 can control auxiliary supply 300, so as to maintain an independent, fixed operating voltage as line input varies across a range of 85-265V (AC or DC) and as the output of the main supply ranges from zero to its maximum.

FIG. 4 shows a schematic diagram of main variable DC power supply 400. Operating (low) voltage is supplied to the ICs at connection 120 and power input (high) voltage is supplied at connection 130. Pulse width modulating device 82, is configured to provide a square wave drive signal of from less than 10% “on time” to over 90% “on time” (in this example, an SG3524, running at 425 KHz). As above, operating at frequency rates above 1,000 Hz is preferred, inasmuch as, higher frequencies, up to a probable upper limit of 4 MHz, allow the use of smaller circuit components. This signal is fed to a switching circuit, in this example, the switching circuit comprises driving device 84, shown with the numbered pin connections of a TC 427, and with switching device 86 being a MOFSET. Switching device 86 controls current flow through transformer 88, and thus the amount of power transferred to the output circuitry and the load connections 140 and 150 for an unshown power dissipating load. The turns ratio from primary to secondary is set to provide the maximum output voltage (or current) expected at the load with the input voltage to rectifying bridge 54 at its minimum, and the duty cycle (on time/off time) at its maximum of around 90%. The output of main supply 400 can be controlled by varying the “On-Off” duty cycle across its range of approximately 10% “On” to 90% “On”. Diodes 90 and 92, together with inductor 94 and capacitor 96, rectify and filter the output of transformer 88. Diodes 90 and 92, together with inductance 94 and capacitor 96, are in a standard buck configuration, but if transformer 88 were not used, inductance 94 would saturate above a 50% duty cycle and at 60% would probably overload MOSFET 86 to failure.

In a conventional “buck” circuit the inductor functions to reduce the switched DC high voltage down to the expected output voltage. As long as the magnetic field can continue to grow as current is applied to the inductor, the expanding magnetic field generates an opposing current that acts to limit current flow. This opposing current, in combination with the impedance or resistance of the load determines the output voltage. When the core has become fully magnetized, the inductor is said to be saturated, and expansion of the magnetic field stops. Without a moving magnetic field, there is no generation of an opposing current, and the inductor acts simply as a piece of wire across the load. It is important that the DC high voltage remain “Off” for a long enough time for all of the magnetic field to be converted to electrical current. Without this power absorbing magnetic field growth, current overload will explosively blow the MOSFET if not the load.

In the power supply of the present invention, the “buck” section is active until the inductor is saturated and, from that point on, the total circuit behaves in a transformer based feed forward mode. Without the “buck” circuit components, the low voltage portion of out output range would be subject to “load sag” high percentage of ripple and would have a very difficult time going down to actual zero volts out. At low duty cycle, the secondary of transformer 88 delivers a narrow “On” pulse through diode (90) and inductor 94 to filter capacitor 96 and load connection 140. This provides an increasing magnetic field, with the opposing electrical current, so generated. When the pulse goes “Off” the collapsing magnetic field generates continuing current through diode 92 to load connection 140. This process continues as long as all the magnetic field created in the core during the “On” time can be removed during the “Off” time. When more magnetizing force is applied during “On-time” than is removed during “Off-time”, the core remains fully magnetized. This occurs around 50% duty cycle, and at this point, with the inductor 94 becoming equivalent to a short piece of wire, filtering is provided entirely by capacitor 96. The turns ratio of transformer 88, its impedance and other basic design factors serve to prevent damage to MOSFET 86.

If a boost/buck circuit were used, instead of a transformer followed by a buck stage, the overall supply would be more complex, the duty cycle timing would be very critical and, maximum power output would be reduced. Also, inasmuch as the inductor would act as both primary and secondary, the efficiency would be reduced.

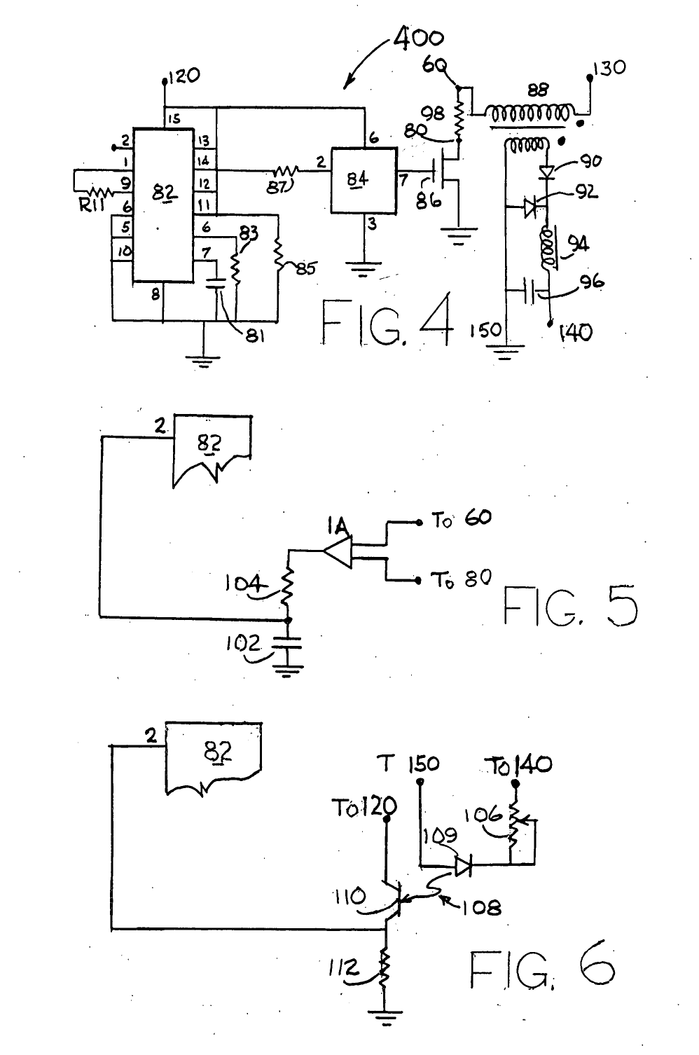

FIG. 5 illustrates an example of feedback control for the current output of main supply 400, for applications requiring current regulation, such as an LED drive. Since all output power must pass through the primary of transformer 88, sensing the voltage drop across low value resistor 98 at points 60 and 80 gives a control voltage proportional to the current output of transformer 88. Inasmuch as sensing is all on the primary side of transformer 88, current output is fully isolated and independent of variations in line voltage.

Instrument Amplifier IA amplifies the small control voltage and charges capacitor 102 through resistor 104. The set point can be adjusted by varying the gain of IA or by varying resistor 104. Thus, this voltage provides a feedback signal to pin 2 of the SG3524 pulse width modulator 82, decreasing the pulse width modulation “on-time/off-time” ratio, at the operating frequency rate, as the feedback signal increases above the set-point value, and increasing the pulse width modulation “on-time/off-time” ratio, at the frequency rate, as the voltage to resistor 112 decreases below the set-point equivalent value equivalent.

FIG. 6 shows a means of regulating voltage output. Variable resistance 106 sets the amount of current allowed to flow through the LED portion 109 of optocoupler 108 and acts to provide an adjustable set-point. The brightness of LED portion 109 controls the resistance of optocoupler transistor portion 110. As the brightness of LED 109 increases, the resistance of transistor 110 also increases and the voltage to grounded resistor 112 decreases. This voltage provides controlling feedback to pin 2 of the SG3524 pulse width modulator 82, decreasing the pulse width modulation “on-time/off-time” ratio, at the operating frequency, as the voltage to resistor 112 rises above the set-point equivalent value. In a like manner, if output voltage falls below the set-point, the brightness of LED 109 decreases; the resistance of diode 110 decreases; and the voltage to resistor 112 and pin 2 increases. This causes a decrease in the pulse width modulation “on-time/off-time” ratio, at the operating frequency, so as to bring output voltage back to the set-point. Since the connection between the primary side of transformer 88 and the transformer output is purely optical, output voltage is isolated from the line.

Feedback control for driving TECs may use a thermistor as the variable resistance 106 to measure the temperature of the controlled environment. When this temperature is above the selected set point, a voltage feedback signal to the SG3524 pulse width modulator 82 increases the “on-time/off-time” ratio appropriately. Prior art circuitry can be adapted to ramp this feedback smoothly ramp up or down, softening the effect of sudden TEC drive changes upon start-up and thereby, reducing thermal stress or shock to the TECs.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of selection and arrangement of parts within the scope and principles of the inventions. The specific examples above do not point out what an infringement of this patent would be, but do provide at least one explanation of how to use and make the inventions. The limits of the inventions and bounds of the patent protection are measured and defined by the following claims.

I claim:

1. A method for converting line voltage to provide a variable power supply with an output ranging from zero up to maximum capacity, comprising the steps of:
rectifying the line voltage, if A.C., to provide a DC power supply voltage and an independent DC low voltage source for operating integrated circuit switching and control components;
connecting the DC power supply voltage source to a first transformer input;
switching the DC voltage connected to the first transformer “Off” and “On”, in a selected pulse width modulated mode of from 0% to more than 60% “on-time”, at a frequency above 1,000 Hz
connecting the first transformer output to a power dissipating load;
rectifying the first transformer output and filtering it through a “buck” stage to permit pulse width control in excess of 60% “on-time”; and
controlling the first transformer power output to the power dissipating load at any selected level from zero to maximum by varying the “on-time” percentage from 0% to above 60%.

2. The method of claim 1 wherein providing the DC low voltage source further comprises the steps of:
connecting a second transformer to the DC power supply voltage source;
tapping the DC power supply voltage source to charge a capacitor so as to provide loss free start-up low voltage for operating integrated circuits;
modulating the start-up low voltage at a frequency above 1,000 Hz to activate the second transformer; and
supplanting the start-up voltage with voltage provided by the second transformer.

3. The method of claim 1 wherein providing the DC low voltage source further comprises the steps of:
tapping the power supply voltage source to charge a capacitor so as to provide a AC low voltage source;
rectifying the AC low voltage to provide DC low voltage; and
paralleling the DC low voltage with a zener diode selected to regulate the voltage level as desired for operating integrated circuits.

4. The method of claim 1 wherein controlling transformer power output to the power dissipating load further comprises the steps of:
providing a voltage drop across a resistor in the first transformer input circuit, so as to isolate the control circuit from the power output circuit;
determining the set-point voltage drop value across the resistor equivalent to the desired first transformer output current;
decreasing the pulse width modulation “on-time/off-time” ratio as the voltage drop increases above the set-point equivalent value; and
increasing the pulse width modulation “on-time/off-time” ratio as the voltage drop decreases below the set-point equivalent value.

5. The method of claim 1 wherein controlling first transformer power output to the power dissipating load further comprises the steps of:
providing a current proportional to the voltage across the power dissipating load;
passing the current through the LED portion of an optocoupler so as to control the resistance of its transistor portion;
determining the set-point voltage drop across the transistor portion equivalent to the desired output current;
sensing the voltage drop across the transistor portion;
decreasing the pulse width modulation “on-time/off-time” ratio as the voltage drop increases above the set point equivalent value; and
increasing the pulse width modulation “on-time/off-time” ratio as the voltage drop decreases below the set point equivalent value.

6. The method of claim 2 wherein controlling first transformer power output to the power dissipating load further comprises the steps of:
providing a voltage drop across a resistor in the first transformer input circuit;
determining the set-point voltage drop value across the resistor equivalent to the desired first transformer output current;
decreasing the pulse width modulation “on-time/off-time” ratio to the first transformer as the voltage drop increases above the set-point equivalent value; and
increasing the pulse width modulation “on-time/off-time” ratio to the first transformer as the voltage drop decreases below the set-point equivalent value.

7. The method of claim 2 wherein controlling first transformer power output to the power dissipating load further comprises the steps of:
providing a current proportional to the voltage across the power dissipating load;
passing the current through the LED portion of an optocoupler so as to control the resistance of its transistor portion;
determining the set-point voltage drop across the transistor portion equivalent to the desired output current;
sensing the voltage drop across the transistor portion;
decreasing the pulse width modulation “on-time/off-time” ratio to the first transformer as the voltage drop increases above the set point equivalent value; and
increasing the pulse width modulation “on-time/off-time” ratio to the first transformer as the voltage drop decreases below the set point equivalent value.

8. The method of claim 3 wherein controlling first transformer power output to the power dissipating load further comprises the steps of:
providing a voltage drop across a resistor in the first transformer input circuit;
determining the set-point voltage drop value across the resistor equivalent to the desired transformer output current;
decreasing the pulse width modulation “on-time/off-time” ratio as the voltage drop increases above the set-point equivalent value; and
increasing the pulse width modulation “on-time/off-time” ratio as the voltage drop decreases below the set-point equivalent value.

9. The method of claim 3 wherein controlling first transformer power output to the power dissipating load further comprises the steps of:
providing a current proportional to the voltage across the power dissipating load;
passing the current through the LED portion of an optocoupler so as to control the resistance of its transistor portion;
determining the set-point voltage drop across the transistor portion equivalent to the desired output current;
sensing the voltage drop across the transistor portion;
decreasing the pulse width modulation “on-time/off-time” ratio as the voltage drop increases above the set point equivalent value; and
increasing the pulse width modulation “on-time/off-time” ratio as the voltage drop decreases below the set point equivalent value.

10. A method for converting line voltage to provide an independent power supply source, comprising the steps of:
rectifying and filtering A.C. line voltage if required, to provide a DC voltage source;
connecting the DC voltage source to the primary winding of a first transformer;
tapping the DC voltage source through a dropping resistor so as to charge a capacitor and provide a start-up low voltage power supply for operating a pulse width modulating integrated circuit;
pulse modulating the start-up low voltage at a frequency above 1,000 Hz;
driving an on/off switching device in the first transformer primary winding at the frequency, so as to drive the first transformer;
supplanting the start-up voltage power supply with power taken from the first transformer secondary winding; and
providing an independent supply source of up to 36VDC from the first transformer output.

11. A method according to 10, and further comprising the steps of:
connecting the DC voltage source to the primary winding of a second transformer;
providing pulse width modulating and switching circuits powered by the independent power supply source for the second transformer input circuit,
switching the DC voltage to the second transformer “Off” and “On”, in a selected pulse width modulated mode of from 0% to more than 60% “on-time”, at a frequency rate above 1,000 Hz;
connecting the second transformer output to a power dissipating load;
filtering the second transformer output through a “buck” stage to permit pulse width control in excess of 60% “on-time”; and
controlling second transformer output to the power dissipating load at any selected level from zero to maximum by varying the “on-time” percentage from 0% to above 60% at the frequency rate.

12. The method of claim 11 wherein controlling second transformer power output to the power dissipating load further comprises the steps of:
providing a voltage drop across a resistor in the second transformer input circuit;
determining the set-point voltage drop value across the resistor equivalent to the desired second transformer output current;
decreasing the pulse width modulation “on-time/off-time” ratio for the second transformer as the voltage drop increases above the set-point equivalent value; and
increasing the pulse width modulation “on-time/off-time” ratio for the second transformer as the voltage drop decreases below the set-point equivalent value.

13. The method of claim 11 wherein controlling second transformer power output to the power dissipating load further comprises the steps of:
providing a current proportional to the voltage across the power dissipating load;
passing the current through the LED portion of an optocoupler so as to control the resistance of its transistor portion;
determining the set-point voltage drop across the transistor portion equivalent to the desired output current;
sensing the voltage drop across the transistor portion;
decreasing the pulse width modulation “on-time/off-time” ratio for the second transformer as the voltage drop increases above the set-point equivalent value; and
increasing the pulse width modulation “on-time/off-time” ratio for the second transformer as the voltage drop decreases below the set-point equivalent value.

14. A method for converting line voltage to provide an independent power supply source, comprising the steps of:
rectifying the AC line voltage to provide a DC voltage power source;
tapping the AC line voltage source to charge a capacitor so as to provide a AC low voltage source;
rectifying the AC low voltage to provide DC low voltage;
paralleling the DC low voltage across a zener diode and a capacitor selected to regulate the DC voltage level as necessary for operating integrated circuits;
connecting the DC voltage power source to the primary winding of a transformer;
providing pulse width modulating and switching circuits powered by the independent supply source;,
switching the DC voltage connected to the primary of the transformer “Off” and “On”, in a selected pulse width modulated mode of from 0% to more than 60% “on-time”, at a frequency rate above 1,000 Hz;
connecting the transformer output to a power dissipating load;
filtering the transformer output through a “buck” stage to permit pulse width control in excess of 60% “on-time”; and
controlling transformer output to the power dissipating load at any selected level from zero to maximum by varying the “on-time” percentage from 0% to above 60% at the frequency rate.

15. The method of claim 14 wherein controlling transformer power output to the power dissipating load further comprises the steps of:
providing a voltage drop across a resistor in the transformer input circuit;
determining the set-point voltage drop value across the resistor equivalent to the desired transformer output current;
decreasing the pulse width modulation “on-time/off-time” ratio as the voltage drop increases above the set-point equivalent value; and
increasing the pulse width modulation “on-time/off-time” ratio as the voltage drop decreases below the set-point equivalent value.

16. The method of claim 14 wherein controlling transformer power output to the power dissipating load further comprises the steps of:
providing a current proportional to the voltage across the power dissipating load;
passing the current through the LED portion of an optocoupler so as to control the resistance of its transistor portion;
determining the set-point voltage drop across the transistor portion equivalent to the desired output current;
sensing the voltage drop across the transistor portion;
decreasing the pulse width modulation “on-time/off-time” ratio as the voltage drop increases above the set point equivalent value; and
increasing the pulse width modulation “on-time/off-time” ratio as the voltage drop decreases below the set point equivalent value.
